(19) United States
(12) Patent Application Publication
(10) Pub. No.: US 2010/0148656 A1
(43) Pub. Date: Jun. 17, 2010

(54) ELECTRON COLUMN USING CNT-TIP AND METHOD FOR ALIGNMENT OF CNT-TIP

(76) Inventor: Ho Seob Kim, Incheon (KR)

Correspondence Address: PARK LAW FIRM, 3255 WILSHIRE BLVD, SUITE 1110, LOS ANGELES, CA, 90010, US

(21) Appl. No.: 12/600,331

(22) PCT Filed: May 28, 2008
(86) PCT No.: PCT/KR2008/002997

§ 371 Date: Nov. 16, 2009

(30) Foreign Application Priority Data
May 29, 2007 (KR) 10-2007-0052354

(51) Int. Cl. H01J 1/304

(52) U.S. Cl. 313/310; 977/939

(57) ABSTRACT

The present invention relates to an electron column using an electron emission source, to which one or more carbon nanotubes (CNTs) are attached, in an electron column structure including an electron emission source and lenses. More particularly, the present invention relates to a method of easily aligning a carbon nanotube (CNT) tip, and an electron column capable of using the method.

### TECHNICAL FIELD

The present invention relates generally to an electron column using an electron emission source, to which one or more carbon nanotubes (CNTs) are attached, in an electron column structure including an electron emission source and lenses, and, more particularly, to a method of easily aligning a carbon nanotube (CNT) tip, and an electron column capable of using the method.

### BACKGROUND ART

A microcolumn based on an electron emission source and electronic optical components having micro-structures, which operates under the basic principle of a scanning tunneling microscope (STM), was first introduced in the 1980s. The microcolumn is formed by elaborately assembling micro-components together, thus minimizing optical aberrations and forming an improved electron column. A plurality of microcolumns having small structures is arranged, and can then be used in the structure of multi-electron column having a parallel or series arrangement.

FIG. 1 is a view showing the structure of a microcolumn, and illustrates that an electron emission source, a source lens, a deflector, and an Einzel lens are aligned together and radiate an electron beam.

Generally, a microcolumn, which is a representative of micro-electron columns, includes an electron emission source 10 for emitting electrons, a source lens 20 for controlling the emitted electrons, a deflector 30 for deflecting an electron beam, and a focusing lens (an Einzel lens) 40 for focusing the electron beam on a sample S.

A cold field emitter (CFE), a thermal emitter (TE) or a thermal field emitter (TFE) has been used as an electron emission source, which is one of the core elements in existing electron columns. The electron emission source requires stabilized electron emission, high brightness, a small size, low energy spreading and a long lifespan.

Electron columns are classified into single electron columns, each including one electron emission source and electron lenses for controlling an electron beam emitted from the electron emission source, and multi-type electron columns, each including electron lenses for controlling a plurality of electron beams emitted from a plurality of electron emission sources. Such multi-type electron columns may be classified into wafer-type electron columns, each including an electron emission source having a plurality of electron emission source tips provided in one layer, as in a semiconductor wafer, and an electron lens including stacked lens layers individually provided with a plurality of apertures; combination type electron columns each controlling electron beams, emitted from individual electron emission sources, using a single lens layer having a plurality of apertures, as in a single electron column; and a scheme in which single electron columns are mounted and used in one housing. In the case of the combination-type electron columns, an electron emission source is divided into separate sources, and lenses are used in the same manner as the wafer-type electron columns.

The above-described electron emission sources are important elements in microcolumns, and such electron emission sources are also very important parts as electron beam generating sources in various fields (for example, a field emission display (FED) and a scanning field emission display (SFED)) using electron beams.

Furthermore, equipment or apparatus using an electron beam and an electron column can exhibit maximum performance only when an electron emission source is accurately aligned with the center of the optical axis of electron lenses (in particular, a source lens). For this purpose, not only must the tip of the electron emission source be well aligned with the optical axis of the lenses, but the tip itself must also be manufactured or formed to be aligned with the optical axis. Furthermore, in the case in which the tip itself is not formed to be aligned with the optical axis, it is difficult to correct it. Furthermore, as optical aberration increases, the performance of the electron column is degraded.

In particular, there is a growing need for various types of equipment using electron beams in step with the tendency toward small-sized components in semiconductors, display equipment, etc. In order to improve productivity, there is an increasing need for a multi-type electron column in which several electron beams are operated at the same time, and the necessity for an electron emission source suitable for the multi-type further increases.

Accordingly, there is the need for an electron emission source that fulfills the requirements of an electron emission source, can be well aligned, and is appropriate for use in a multi-type application.

### DISCLOSURE OF INVENTION

### Technical Problem

Accordingly, the present invention has been made keeping in mind the above problems occurring in the prior art, and an object of the present invention is to provide an electron emission source using one or more CNTs, which are capable of stably emitting electrons, unlike electron emission sources used in existing electron columns, a method of aligning, and attaching or depositing the CNTs easily, and an electron column using the method.

### Technical Solution

In order to accomplish the above object, the present invention provides an electron column including an electron emission source and an electron lens, wherein the electron emission source is configured such that one or more CNTs are attached to a sharp tip end.

Furthermore, the present invention provides a method of aligning one or more CNTs of an electron emission source to which the CNTs are attached, the method including aligning the electron emission source, on which the CNTs are attached or deposited, with electron lens layers that form electric fields so that electrons are emitted from the electron emission source; and radiating an ion beam onto a CNT tip in a vertical direction through the apertures of the electron lens layers.

In an attempt to use one or more CNTs as a new electron emission source, the present invention provides an electron emission source that is provided with a tip in which one or more CNTs are attached to or deposited on a support, such as that of the CFE tip of an existing electron emission source. However, since the CNTs have a very small size, it is not easy to accurately attach or deposit the CNTs on a support, such as that of the CFE tip, and to align it with lenses. Furthermore, neither is it easy to vertically and accurately align the CNTs at a CFE tip end.

Therefore, the present invention uses a method of attaching or depositing one or more CNTs on the end of a CFE tip as a support having a pointed end, aligning the CNTs with lenses on the basis of the end of the CFE tip, and realigning the CNTs using an ion beam. The reason that, in the present invention, the CFE tip of an electron emission source is used as the support for using the CNTs is that an existing CFE tip and an existing lens alignment method can be used without change and the CNTs can be aligned vertically using an ion beam. Accordingly, if alternative means for alignment with lenses exists, it is not necessary to deposit or attach CNTS on a support such as a CFE tip. For example, in the case in which CNTs are deposited or attached on a wafer in a wafer-type electron column, when the alignment of the CNTs with lenses does not need to be very accurate (for example, in an FED), the CNTs and electron lenses are aligned with each other by marking the wafer, and it is necessary only to align the CNTs vertically using an ion beam without depositing and aligning the CNTs to and with a sharp tip end. Accordingly, in the present invention, a CFE tip on which CNTs are deposited or attached is a reference to facilitate alignment with lenses, and can be replaced with one of various types of supports capable of playing the same role.

### ADVANTAGEOUS EFFECTS

An electron column using one or more CNTs according to the present invention can more easily induce electron emission therein. Accordingly, an electron emission source can be fabricated more easily, and an electron column can be fabricated in the form of a multi-type electron column more easily.

When a method of aligning CNTs according to the present invention is used, an electron column using CNTs can be fabricated easily.

If the method of aligning CNTs according to the present invention is used, CNTs of which the end parts are slightly curved or bent can be realigned and reused.

The method of aligning CNTs according to the present invention can be used in various fields using electron emission sources, such as an electron column, an FED and an SFED.

### BRIEF DESCRIPTION OF THE DRAWINGS

FIG. 1 is a sectional view showing the structure of a micro-electron column;

FIG. 2 is a sectional view illustrating one or more CNTs attached to the tip of an existing CFE electron emission source;

FIGS. 3a and 3b are sectional views showing a concept in which a CNT tip is realigned along an ion beam;

FIG. 4 is a sectional view illustrating one or more CNTs vertically aligned in a micro-column according to the present invention;

FIG. 5 is a sectional view showing a state where the CNT tip 50 of FIG. 4 is aligned;

FIG. 6 is a sectional view illustrating an ion beam I focused on and radiated onto the CNT tip 50 of an electron emission source by applying voltage or current to a source lens in the embodiment of FIG. 4;

FIGS. 7 to 9 are sectional views showing embodiments in which, in the structure of a general electron column, an ion beam I is applied to the CNT tip 50 of an electron emission source; and

FIG. 10 is a perspective view illustrating the alignment of a CNT tip in the case in which an electron column according to the present invention is a multi-type column.

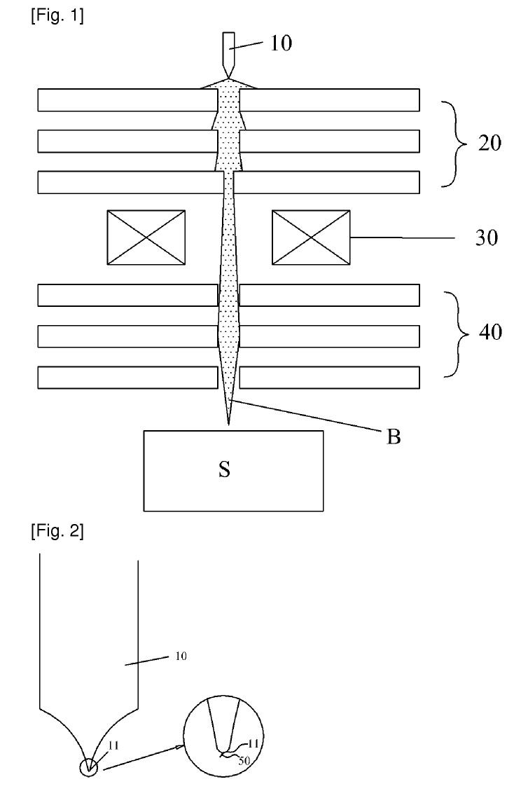

### MODE FOR THE INVENTION

Hereinafter, embodiments of the present invention will be described in detail with reference to the accompanying drawings.

FIG. 2 is a view illustrating one or more CNTs attached to the tip of an existing CFE electron emission source.

In a method of using one or more CNTs in an electron emission source, a CFE electron emission source 10 is formed in such a way that a sharp tip end 11 is obtained by etching tungsten using a KOH solution and one or more CNTs 50 are precisely and vertically attached to or deposited on the sharp tip end 11. However, it is very difficult to precisely and vertically attach or deposit the CNTs 50 on the tip end 11. Therefore, as shown in the drawing, the CNTs 50 are not precisely and vertically attached to the tip end 11, but are attached to the tip end 11 in an inclined state. Furthermore, since the CNTs have a small size, it is difficult to check not only such vertical attachment or deposition but also alignment with the optical axis of lenses. Accordingly, when there is a problem with the alignment, the CNTs must be realigned.

In FIG. 2, the CNTs are attached or deposited using an existing CFE tip, but it is not necessary for a tip end to be sharp or pointed, as in a conventional CFE tip. The reason that the CNTs are attached to or deposited on the sharp tip end is that, at the time of alignment between the electron emission source and the optical axis of the lenses, it is difficult to directly check and align the CNTs, because the CNTs are very small. This is because the alignment between the central axis of a lens aperture and the CNTs is performed using a tip end, on which the CNTs are attached or deposited, instead of the CNTs. Furthermore, since it is convenient to deposit and use a small number of CNTs when a tip end is sharp, it is preferred that the tip end be sharp. Accordingly, when a large number of CNTs are necessary depending on the environment of use or the purpose (for example, an FED or an SFED), the sharpness of a deposited tip end can be decreased. Although it may vary depending on the environment of use, it is preferred that, when field emission is used and precise and stable field emission is required, CNTs be generally attached to the tip end or the support end within the available range of an existing CFE in a micro-electron column, and then be used.

In the case in which a CNT tip is used in an electron emission source, the present invention is intended to radiate and realign an ion beam in the state in which the CNT tip, which was not precisely aligned, as shown in FIG. 2, is aligned with a source lens, etc.

The present invention uses the fact that, when an ion beam is radiated onto a CNT tip having one free end, the CNT tip is bent in the direction of the ion beam, as disclosed in a thesis by Byong C. Park et al, entitled “Bending of a Carbon Nanotube in a Vacuum Using a Focused Ion Beam” in Advanced Materials pp. 95-98, which was published in 2006.

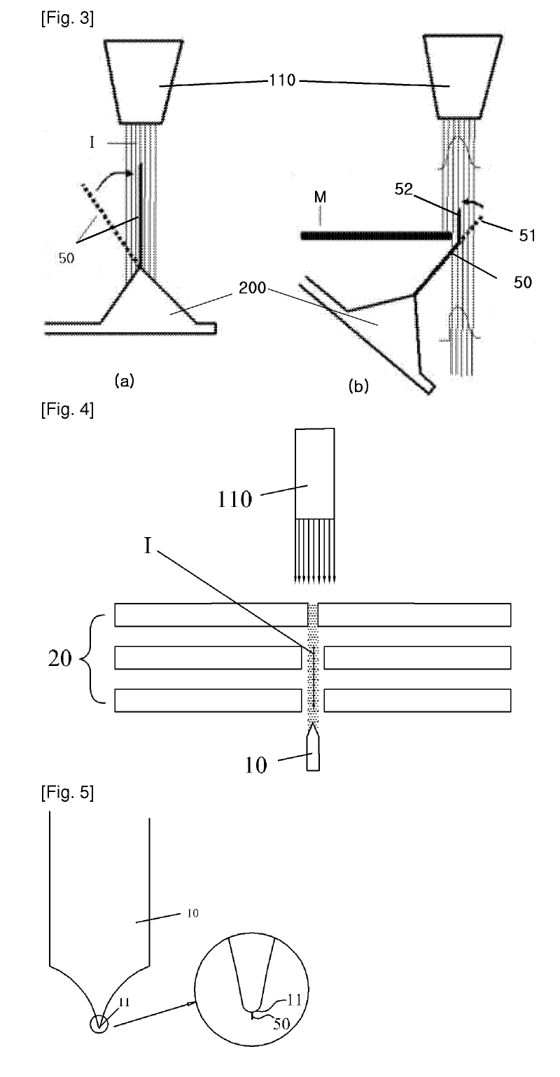

FIGS. 3a and 3b are conceptual views illustrating a CNT tip realigned along an ion beam.

Referring to FIG. 3a, the CNT tip 50 is attached to a support 200 in an inclined state, as indicated by a dotted line. In this state, when an ion beam I is vertically radiated from an ion beam source 110, the CNT tip 50 is illustrated as being vertically realigned along the ion beam. Referring to FIG. 3b, in the state in which the CNT tip 50, aligned, as shown in FIG. 3a, is inclined, the ion beam I is radiated onto the CNT tip 50 again. The CNT tip 50 is partially covered with a mask M, and only an end 51 of the CNT tip 50 is exposed to the ion beam I. The CNT tip end 51 of the exposed portion is indicated by a dotted line. When, in this state, the ion beam I is vertically radiated from the ion beam source 110, an end 52 of the CNT tip 50 is vertically aligned along the ion beam.

The present invention is constructed by applying the principle of the realignment of a CNT tip using an ion beam to an electron emission source. The present invention is intended to realign one or more CNTs using the characteristic that, when an ion beam is radiated on the CNTs in the case in which the CNTs 50 are inclined with respect to the tip end 11 of the electron emission source without being vertically aligned therewith, as shown in FIG. 2, the CNTs are vertically aligned in the direction of the ion beam.

FIG. 4 is a diagram illustrating one or more CNTs vertically aligned in a microcolumn according to the present invention. FIG. 4 shows the state in which an electron emission source 10, in which the CNT tip 50 is attached to the tip end 11 of FIG. 2, is aligned and combined with a source lens 20 on the basis of the tip end 11. In this aligned state, an ion beam from an ion beam source 110 passes through an aperture of the source lens 20 and is then radiated onto the CNT tip 50. The CNT tip 50 is vertically aligned by the radiated ion beam I. That is, the ion beam is radiated in a direction opposite that in which an electron beam is emitted in an existing electron column. Here, the ion beam may proceed vertically toward the tip in a parallel beam form, and it is also preferred that the ion beam be focused and radiated onto the tip end 50.

FIG. 5 shows the state in which the CNT tip 50 of FIG. 4 is aligned. When the ion beam I is vertically incident on the tip of the electron emission source in a parallel beam form, as shown in FIG. 4, the CNT tip 50, which is not vertically aligned, as shown in FIG. 2, is vertically realigned with the tip end 11 by the ion beam, as shown in a circle.

In FIGS. 4 and 5, the electron emission source 10 is configured to be aligned in the direction of the ion beam I, which is vertically incident through the aperture of the electron lens through which electrons emitted from the CNT tip 50 will pass, on the basis of the aperture.

In FIGS. 4 and 5, in order to align the electron emission source with the optical axis of the lenses more accurately, it is preferred that the tip end 11 be sharper and smaller.

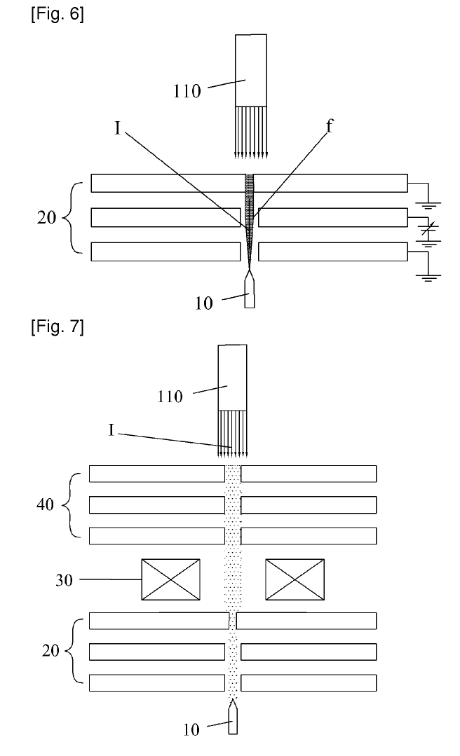

FIG. 6 illustrates that the ion beam I is focused on and radiated onto the CNT tip 50 of the electron emission source by applying voltage or current to the source lens in the embodiment of FIG. 4. As shown in FIG. 6, the source lens 20, which includes three lens layers, and the electron emission source 10, to which the CNT tip 50 is attached, are aligned with each other. In this case, when voltage or current is applied to the intermediate layer of the source lens and the remaining upper and lower layers are grounded, an ion beam I is focused on the CNT tip 50, and thus many ions collide with the CNT tip 50. Although precise focusing is not performed, a larger number of ions are radiated onto the CNT tip I through the focusing of the ion beam I, compared to a parallel beam, and, simultaneously, the CNT tip end is decisively aligned with the optical axis of the electron lenses. Therefore, the focused ion beam can realign the CNT tip more precisely than the parallel beam.

FIGS. 7 to 9 are diagrams showing embodiments in which, in a general electron column structure, an ion beam I is applied to the CNT tip 50 of an electron emission source. The present embodiments illustrate examples in which a CNT tip is aligned in a general electron column, which includes an electron emission source 10, provided with the CNT tip 50, a source lens 20, a deflector 30, and a focusing lens 40.

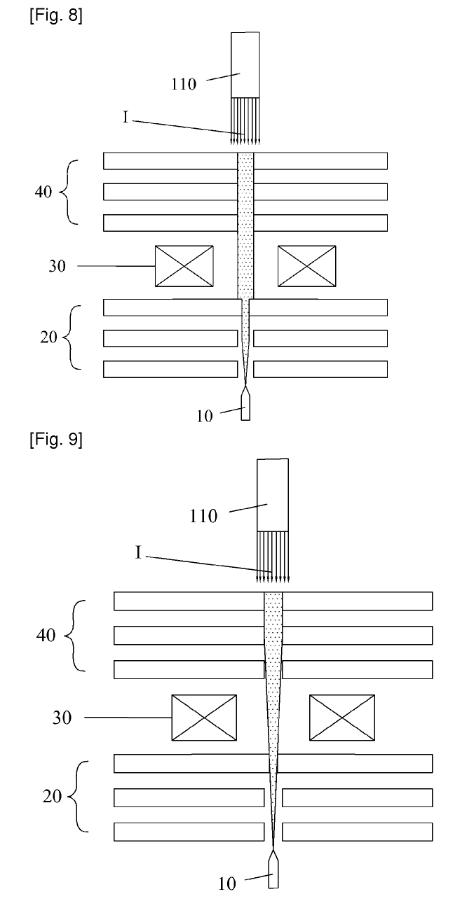

First, FIG. 7 shows a general method in which an ion beam I is vertically incident on an electron column, and shows the state in which separate voltage or current is not applied to the lenses 20 and 40. Accordingly, the ions of the ion beam I are restricted to the smallest aperture of the lenses, and are incident on the CNT tip (not shown). FIG. 8 illustrates that the ion beam I is focused on the electron emission source 10 in the source lens 20, and FIG. 9 illustrates that the ion beam I is focused on the electron emission source 10 in the focusing lens 40. When the ion beam I is focused, the ion beam I is condensed, thereby enabling easier alignment. However, when the focusing is not accurate, it is preferred that alignment be performed using the ion beam Is own parallel beam, as shown in FIG. 7. Therefore, the focusing, shown in FIG. 8 or 9, is preferable when alignment between the electron emission source 10 and other lenses is accurate or data regarding the alignment is accurate. When there is a problem with the alignment between the electron emission source 10 and other lenses or the data is inaccurate, the method shown in FIG. 7 is preferable.

The alignment methods of FIGS. 7 to 9 may be preferable when an electron column is corrected or inspected during use, rather than when an electron column is manufactured. Here, the method described in conjunction with FIG. 6 may be used as a focusing method. Furthermore, when focusing is performed in a completed electron column, focusing control can be performed easily using its wiring. Moreover, although not shown particularly, when the ion beam I needs to be deflected, such deflection can be performed using the deflector 30 at the center, and it can be performed in the same manner as the deflection of an electron beam.

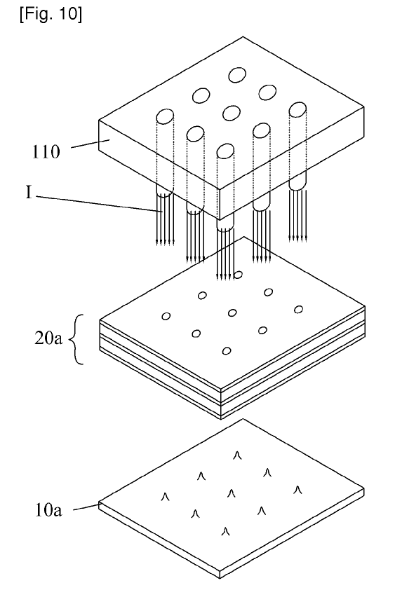

FIG. 10 is a perspective view illustrating the alignment of a CNT tip in the case in which an electron column according to the present invention is a multi-type.

The multi-type electron column is formed by fabricating a plurality of the above-described individual electron columns in the form of a multi-type electron column. A single-type electron column and a multi-type electron column may be distinguished from each other according to the number of electron beams that are emitted from one electron column. For example, the single-type electron column forms one electron beam using one electron emission source, and uses respective lenses in order to control the one electron beam. The multi-type electron column forms and radiates a plurality of electron beams. The multi-type electron column uses a plurality of electron emission sources to form a plurality of electron beams, and uses a corresponding number of electron lenses to control the respective electron beams. Furthermore, the electron columns of FIGS. 4 to 9 may be used based on the concept of unit electron columns, and an n m arrangement bundle of electron columns may also be used. A wafer-type electron column, in which n m lenses or electron emission sources are arranged in one layer of each wafer, as shown in FIG. 10, is used as the multi-type electron column. In particular, in the present invention, the wafer-type electron column is appropriately used as the multi-type electron column.

In FIG. 10, a plurality of electron columns forms a single multi-electron column, unlike the above single type electron column, and a plurality of unit lens layers, including the lenses 20 and 40, is arranged in a single wafer-type layer. Furthermore, a plurality of the CNT tips is formed in one layer to correspond to the lenses, and the electron emission source 10 also corresponds to wafer-type electron lenses as one layer. Therefore, ion beams I are radiated to correspond to respective electron emission sources. The ion beam source 110 may be configured in the form of a multi-ion beam source, as shown in the drawing, to correspond to the number of respective electron emission sources 10 of unit electron columns, or a single very large parallel beam may be formed and radiated onto respective electron emission sources 10 of a multi-electron column. FIG. 10 illustrates 3 3 unit electron columns forming a single multi-electron column. However, the arrangement of the unit electron columns is illustrated for convenience of description, and various arrangements of the unit electron columns are possible. In FIG. 10, all CNT tips can be aligned using the methods shown in FIGS. 4 and 6. In the case in which the multi-type electron column is fabricated in the form of electron columns shown in FIGS. 7 to 9, the CNT tips can be aligned using the methods shown in FIGS. 7 to 9. In FIG. 10, the method of aligning a plurality of CNT tips is the same as the above-described method for the single type electron column, or can be performed using either of two methods, the radiation of a simple parallel ion beam and focusing.

Even when single electron columns are simply arranged in an n m arrangement, the CNT tips 50 can be aligned using the method shown in FIG. 10.

Although, in the above description, the CNT tip 50 has been described as one CNT, a plurality of CNTs may be grown at the tip end 11, for example, using a CVD method, and may then be commercialized. Even in this case, the CNTs can be aligned using the same method as one CNT.

Although, in the above-described FIGS. 2 to 10, an existing CFE, TFE or TE tip may be used as the tip end 11 without change, a support having a flat structure may be used instead of the tip end 11 in order to attach one or more CNTs thereto. In particular, although, in the multi-type electron column, such as that shown in FIG. 10, a CNT tip may be attached to (grown on) a wafer having a flat structure, it is preferable to form an additional sharp support, such as a mountain support, a quadrangular pyramid support or a cone support, and attach or grow a CNT tip on an end of the sharp support, at the time of alignment of an electron emission source with lenses. Furthermore, when the CNT tips are used in fields requiring various electron emission sources, such as an FED or an SFED, the CNT alignment methods described above in conjunction with FIGS. 2 to 10 may be used. In this case, it is preferred that the illustrated tip end 11 be replaced with a support that supports a typical CNT.

The CNT tip alignment method of the multi-type electron column of FIG. 10 can be used as a method that is easily applicable to, in particular, an FED or an SFED. Furthermore, if the alignment can be performed without the need to check the positions of one or more CNTs at the time of aligning the electron emission source, to which the CNTs are attached, with the apertures of the electron lens layers through which electrons from the electron emission source pass, the CNTs may be attached to or deposited on a plane without change.

If the end parts of CNTs are curved or bent, as shown in FIG. 3, the curved or bent end part of the CNTs can be realigned by ion beam, and then the realigned CNTs can be used in an electron column as normal CNTs.

### INDUSTRIAL APPLICABILITY

The CNT alignment method according to the present invention can be used in various fields in which electron emission sources are used, such as an electron column, an FED and an SFED.

Furthermore, the electron column according to the present invention can be used in a radiating electron microscope, semiconductor lithography, or inspection apparatuses using an electron beam, for example, an apparatus for the inspection of the abnormality of the via holes/contact holes of semiconductor devices, an apparatus for surface inspection and the analysis of a sample, and an apparatus for the inspection of the abnormality of a Thin Film Transistor (TFT) in an TFT-LCD device.

What is claimed is:

1. An electron column including an electron emission source and electron lenses, wherein the electron emission source uses one or more carbon nanotubes (CNTs) in order to emit electrons.

2. The electron column as set forth in claim 1, wherein the CNTs are attached to or deposited on a sharp end of a support including a cold field emitter (CFE), a thermal field emitter (TFE), or a thermal emitter (TE).

3. The electron column as set forth in claim 1, wherein the electron column is a multi-type and wafer-type electron column, and the CNTs are formed on a plane of a wafer.

4. The electron column as set forth in claim 3, wherein the CNTs are formed at a sharp end of a support of the wafer.

5. The electron column as set forth in claim 2, wherein the sharp end of the support is aligned with the electron lenses.

6. The electron column as set forth in claim 1, wherein the CNTs are vertically aligned in a radiation direction of an ion beam by the ion beam.

7. A method of aligning one or more CNTs of an electron emission source to which the CNTs are attached, the method comprising:
aligning the electron emission source on which the CNTs are attached or deposited with electron lens layers that form electric fields so that electrons are emitted from the electron emission source; and
radiating an ion beam onto a carbon nanotube (CNT) tip in a vertical direction through apertures of the electron lens layers.

8. The method as set forth in claim 7, wherein, when the electron emission source is used in the electron column, the electron lens layer is a source lens layer that comprises an extractor.

9. The method as set forth in claim 7, wherein the electron emission source is an electron emission source that is used in any one of a field emission display (FED) and a scanning field emission display (SFED).

10. The method as set forth in claim 7, wherein the ion beam is focused on and radiated onto the CNT tip.

11. The electron column as set forth in claim 4, wherein the sharp end of the support is aligned with the electron lenses.

12. The electron column as set forth in claim 2, wherein the CNTs are vertically aligned in a radiation direction of an ion beam by the ion beam.

13. The electron column as set forth in claim 3, wherein the CNTs are vertically aligned in a radiation direction of an ion beam by the ion beam.

14. The electron column as set forth in claim 4 wherein the CNTs are vertically aligned in a radiation direction of an ion beam by the ion beam.

15. The electron column as set forth in claim 5, wherein the CNTs are vertically aligned in a radiation direction of an ion beam by the ion beam.

16. The method as set forth in claim 8, wherein the ion beam is focused on and radiated onto the CNT tip.

17. The method as set forth in claim 9, wherein the ion beam is focused on and radiated onto the CNT tip.
